(19) United States
(12) Patent Application Publication
(10) Pub. No.: US 2022/0207266 A1
(43) Pub. Date: Jun. 30, 2022

(54) METHODS, DEVICES, ELECTRONIC APPARATUSES AND STORAGE MEDIA OF IMAGE PROCESSING

(71) Applicant: SENSETIME INTERNATIONAL PTE. LTD., Singapore (SG)

(72) Inventors: Bairun WANG, Singapore (SG); Xuesen ZHANG, Singapore (SG); Chunya LIU, Singapore (SG); Jinghuan CHEN, Singapore (SG); Shuai YI, Singapore (SG)

(21) Appl. No.: 17/347,877

(22) Filed: Jun. 15, 2021

Related U.S. Application Data
(63) Continuation of application No. PCT/IB2021/054306, filed on May 19, 2021.

(30) Foreign Application Priority Data
Dec. 31, 2020 (SG) 10202013266S

(51) Int. Cl. G06K 9/00; G06K 9/32; G06K 9/62

(52) U.S. Cl. CPC G06K 9/00362; G06K 9/00335; G06K 9/6256; G06K 9/3233

(57) ABSTRACT

Methods, devices, electronic apparatuses and storage media of processing images, training neural networks, and recognizing human body actions are provided. In one aspect, a method of image processing includes: acquiring a human body bounding box and a target key point corresponding to a target body part in an image and acquiring first correlation information between the human body bounding box and the target key point; generating a target bounding box for the target body part according to the target key point and the human body bounding box; and determining, according to the first correlation information and pre-labeled second correlation information indicating correlation between a first body part and the human body bounding box, third correlation information to indicate a correlation between the target bounding box and a first bounding box for the first target body part.

### CROSS REFERENCE TO RELATED APPLICATIONS

This application is a continuation application of International Application No. PCT/IB2021/054306 filed on May 19, 2021, which claims priority to a Singapore Patent Application No. 10202013266S entitled “METHODS, DEVICES, ELECTRONIC APPARATUSES AND STORAGE MEDIA OF IMAGE PROCESSING” and filed on Dec. 31, 2020, the entire contents of which are incorporated herein by reference.

### TECHNICAL FIELD

Embodiments of the present disclosure relates to image processing technology, and in particular to methods, devices, electronic apparatuses and storage media of image processing.

### BACKGROUND

With the development of artificial intelligence technology, neural networks are more and more widely used in data detection and discrimination, thereby reducing labor costs and improving efficiency and accuracy. Training of neural networks requires mass labeled training samples as training sets. The neural network configured to recognize correlation between human body parts requires images labeled with information on various parts of human body. However, it is currently impossible to efficiently and accurately label the human body parts involved in image, so it is difficult to acquire sufficient training samples, the efficiency and accuracy of training model are all adversely affected.

### SUMMARY

Embodiments of the present disclosure provide methods, devices, electronic apparatus, and storage medium of image processing to solve the deficiencies in related technologies.

According to a first aspect of the present disclosure, a method of processing image is provided, including: acquiring a human body bounding box and a target key point corresponding to a target body part in an image, and first correlation information between the human body bounding box and the target key point; generating a target bounding box for the target body part according to the target key point and the human body bounding box; determining third correlation information according to the first correlation information and pre-labeled second correlation information, wherein the second correlation information indicates correlation between a first body part and the human body bounding box, and the third correlation information indicates a correlation between the target bounding box and a first bounding box for the first body part.

According to a second aspect of the present disclosure, there is provided a method of training a neural network, the neural network is configured to detect a correlation between body parts involved in an image, and the method includes: training the neural network with an image training set; wherein, an image in the image training set is labeled with label information, the label information includes correlation information between a first body part and a target body part involved in the image, and the correlation information is determined according to the method described in the first aspect.

According to a third aspect of the present disclosure, there is provided a method of recognizing an action, including: recognizing an action of a human body involved in an image based on correlation information between a first body part and a target body part involved in the image, wherein the correlation information is acquired with the neural network trained by the method described in the second aspect.

According to a fourth aspect of the present disclosure, there is provided a device of processing image, including: a key point acquiring module, configured to acquire a human body bounding box and a target key point corresponding to a target body part in an image and first correlation information between the human body bounding box and the target key point,; a bounding box generating module, configured to generate a target bounding box for the target body part according to the target key point and the human body bounding box; a correlation information determining module, configured to determine third correlation information according to the first correlation information and pre-labeled second correlation information, wherein the second correlation information indicates a correlation between a first body part and the human body bounding box, and the third correlation information indicates a correlation between the target bounding box and a first bounding box for the first body part. In some embodiments, the correlation information determining module is configured to: acquiring orientation discriminating information of the first body part that includes at least one of two second symmetrical parts of the human body; in response to determining that the first bounding box and the target bounding box are both correlated with the human body bounding box and that orientation discrimination information of the first bounding box is same as orientation discrimination information of the target bounding box, correlating the first bounding box and the target bounding box according to the first correlation information and the pre-labeled second correlation information, where the orientation discrimination information of the first bounding box corresponds to the orientation discriminating information of the first body part, and the orientation discrimination information of the target bounding box corresponds to the orientation discriminating information of the target body part; and generating the third correlation information according to a result of correlating the first bounding box and the target bounding box.

According to a fifth aspect of the present disclosure, there is provided a device of training a neural network which is configured to detect a correlation between body parts involved in an image, the device includes: a training module, configured to train the neural network with an image training set; wherein an image in the image training set is labeled with label information, and the label information includes correlation information between a first body part and a target body part involved in the image, and the correlation information is determined according to the method described in the first aspect.

According to a sixth aspect of the present disclosure, there is provided a device of recognizing an action, the device including: a recognizing module, configured to recognize an action of a human body involved in an image based on correlation information between a first body part and a target body part involved in the image, wherein the correlation information is acquired with the neural network trained by the method according to the second aspect of the present disclosure.

According to a seventh aspect the present disclosure, there is provided an electronic apparatus, including a memory and a processor, wherein the memory is configured to store computer instructions executable by the processor, and the processor is configured to implement operations of the method according to the first aspect, the second aspect or the third aspect in a case of executing the computer instructions.

According to an eighth aspect of the present disclosure, there is provided a computer-readable storage medium having a computer program stored thereon, operations of the method according to the first aspect, the second aspect or the third aspect are implemented in a case of the computer program being executed by a processor.

According to the foregoing embodiments, it can be known that, by acquiring a human body bounding box and a target key point in an image as well as first correlation information between the human body bounding box and the target key point, the target key point corresponds to a target body part, body bounding boxes for various human bodies involved in the image may be acquired accurately and a target key point associated with each of the body bounding boxes may be acquired; further, a target bounding box for the target body part may be generated according to the target key point and the human body bounding box; and finally, third correlation information between the target body part and a first body part may be determined according to the first correlation information and pre-labeled second correlation information between the first body part and the human body bounding box, and thus, the target body part and the first body part may be automatically correlated. The determined third correlation information may be used as label information of the target body part involved in the image, which solves the problem of inefficient manual labeling and improves the efficiency of labeling correlation between body parts involved in the image.

It should be understood that the above general description and the following detailed description are only exemplary and explanatory, and cannot be construed as a limit to the present disclosure.

### BRIEF DESCRIPTION OF THE DRAWINGS

The drawings herein incorporated into the specification and constituting a part of the specification, illustrates embodiments in accordance with the present disclosure, and are used along with the specification to explain the principle of the present disclosure.

FIG. 1 illustrates a flowchart of a method of processing image according to an embodiment of the present disclosure;

FIG. 2 illustrates a schematic processing result of an image according to an embodiment of the present disclosure;

FIG. 3 illustrates a schematic structural diagram of a device of processing image according to an embodiment of the present disclosure; and

FIG. 4 illustrates a schematic structural diagram of an electronic apparatus according to an embodiment of the present disclosure.

### DETAILED DESCRIPTION OF THE EMBODIMENTS

The exemplary embodiments will be described in detail here, and examples thereof are illustrated in the accompanying drawings. When the following description refers to the accompanying drawings, unless otherwise stated, the same reference signs in different drawings designate the same or similar elements. The implementation manners described in the following exemplary embodiments do not represent all implementation manners consistent with the present disclosure. On the contrary, they are merely examples of devices and methods consistent with some aspects of the present disclosure as defined in the appended claims.

The terms used in the present disclosure are only for the purpose of describing specific embodiments and are not intended to limit the present disclosure. The singular forms of “a”, “said” and “the” used in the present disclosure and the appended claims are also intended to include plural forms, unless the context clearly indicates other meanings. It should also be understood that the term “and/or” used herein refers to and includes any or all possible combinations of one or more associated listed items.

It should be understood that although the terms first, second, third, etc. may be used in the present disclosure to describe various information, the information should not be limited by these terms. These terms are only used to distinguish the same type of information from each other. For example, without departing from the scope of the present disclosure, the first information may also be referred to as the second information, and similarly, the second information may also be referred to as the first information. Depending on the context, the term “if” used herein may be interpreted as “in a case of” or “upon” or “in response to determination”.

With the development of artificial intelligence technology, neural networks may detect and discriminate data, reduce labor costs, and improve efficiency and accuracy. Training a neural network requires mass labeled training samples as a training set. Human body images for training an action recognizing model requires various human body parts to be labeled, and the labeling cannot be efficiently and accurately performed in related technologies, so the efficiency and accuracy of model training are adversely affected.

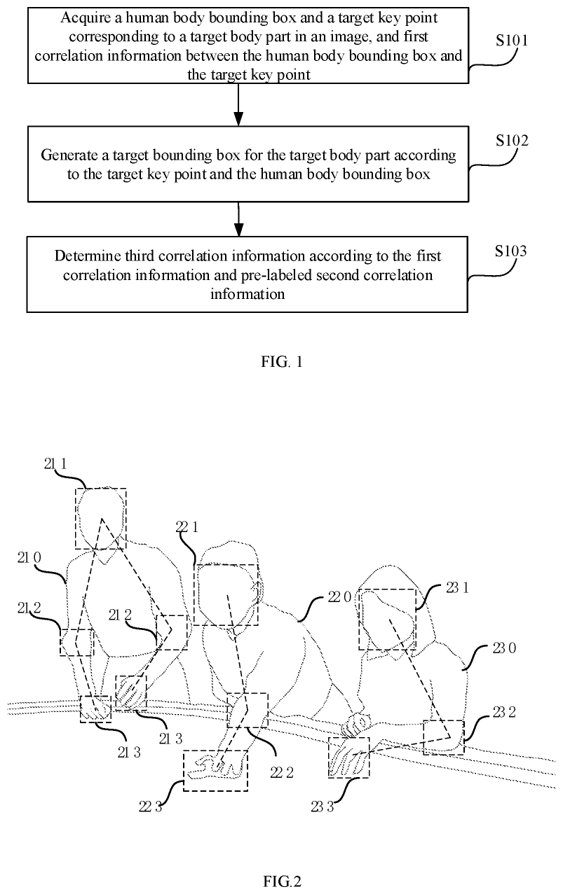

In view of this, in the first aspect, at least one embodiment of the present disclosure provides a method of processing image. Please refer to FIG. 1, which illustrates the flow of the method, including step S101 to step S103.

The image aimed by the method of processing image maybe an image for training a neural network model, wherein the neural network model may be a model configured to recognize an action of a human body. For example, the model can be configured to recognize actions of game players in a board game scene. In an exemplary application scenario, a video may be recorded during a table game, and then the video is input into the above model. The model may recognize actions of each person in each frame of the video; and the model may recognize actions by recognizing several parts of the human body. The image aimed by the method of processing image involves at least one human body, and positions of several body parts of the at least one human body have been previously labeled with a rectangular frame or the like.

In step S101, a human body bounding box and a target key point corresponding to a target body part in an image, and first correlation information between the human body bounding box and the target key point are acquired.

The image involves at least one human body, each of which corresponds to a human body bounding box. The human body bounding box can completely surround its corresponding human body, and the human body bounding box may be the smallest frame surrounding the corresponding human body. The shape of the human body bounding box may be a rectangle or any other suitable shape, which is not limited in the present disclosure. The human body bounding box contains at least one target key point which corresponds to a target body part of the human body, such as a wrist, a shoulder, an elbow and other body part. A target body part of the human body corresponds to at least one target key point. The number of target key points corresponding to different target body parts of the human body may be identical or different, which is not limited in the present disclosure.

In this step, the human body bounding box may be obtained as follows: a key point of a human body may be detected from the image, margin of the human body object may be determined, and the human body bounding box surrounding the human body object can be constructed, thereby determining a position of the human body bounding box in the image. Specifically, in a case that the human body bounding box is rectangular, coordinates of the four vertices of the rectangular bounding box may be acquired.

Acquiring the target key point corresponding to the target body part may include: acquiring position information of the target key point in the image, for example, acquiring the coordinates of one or more pixel points corresponding to the target key point. The position of the target key point may be determined by detecting the target key point in the human body bounding box or by detecting the target key point in the image according to a relative position feature of the target body part in the human body.

The first correlation information between the target key point and the human body bounding box includes a belonging relationship between the target key point and a human body corresponding to the human body bounding box, that is, in a case that the target key point belongs to the human body involved in the human body bounding box, the target key point and the human body bounding box are correlated, and on the contrary, in a case that the target key point does not belong to the human body involved in the human body bounding box, the target key point and the human body bounding box are not correlated. The first correlation information may be determined based on positions of the human body bounding box and the target key point.

In an example, a target body part includes any one of followings: a human face, a human hand, an elbow, a knee, a shoulder, and a human foot. Accordingly, the target key point corresponding to the target body part includes any one of followings: a key point of the human face, a key point of the human hand, a key point of the elbow, a key point of the knee, a key point of the shoulder and a key point of the human foot.

In step S102, a target bounding box for the target body part is generated according to the target key point and the human body bounding box.

The target body part is a position that needs to be labeled in the image and/or a body part of a correlated human body or other body part. A surrounding frame surrounding the target key point may be generated as a bounding box for a corresponding target body part according to position of the acquired target key point.

In a case that there are a plurality of target body parts that need to be labeled, these target body parts can be labeled in batches. Therefore, in this step, bounding boxes for these target body parts may be determined in batches. These target body parts may also be labeled in sequence. Thus, in this step, the bounding boxes for the target body parts may also be determined one by one.

The target key point corresponding to the target body part may be one or more. Therefore, in this step, a bounding box for the target body part may be determined according to the one or more target key points and a corresponding human body bounding box. The bounding box for the target body part may be taken as a position tag for the target body part.

As an example, FIG. 2 illustrates a schematic diagram of a bounding box for a target body part. As illustrated in FIG. 2, an image involves three human bodies 210, 220 and 230, as well as a bounding box 212 for an elbow corresponding to the human body 210, a bounding box 222 for an elbow corresponding to the human body 220, and a bounding box 232 for an elbow corresponding to the human body 230, and the bounding boxes 212 for the elbows appear in pairs, that is, they include the left elbow and the right elbow.

In step S103, third correlation information is determined according to the first correlation information and pre-labeled second correlation information, wherein the second correlation information indicates a correlation between a first body part and the human body bounding box, the third correlation information indicates a correlation between the target bounding box and a first bounding box for the first body part.

The first body part may be a body part that has been labeled, and label information of the first body part may include a position of the bounding box for the first body part and a relationship with the human body. Optionally, the label information of the first body part further includes but is not limited to at least one of a part name and orientation discriminating information.

The second correlation information may be acquired based on the label information of the first body part, and the correlation between the first body part and the human body bounding box may be determined by a correlation between the first body part and the human body involved in the human body bounding box.

The third correlation information may be determined as follows: the human body bounding box is correlated with a target bounding box with which the human body bounding box is correlated; and third correlation information is acquired by correlating a target bounding box and a first bounding box for a first body part that are both correlated with one human body bounding box, according to both a result of correlating the human body bounding box and the target bounding box and the second correlation information.

In an example, the first body part is a human face and the target body part is an elbow, then third correlation information between the human face and the elbow may be determined according to the above method. For details, please refer to FIG. 2, which illustrates three human bodies 210, 220 and 230. A first body part of the human body 210 is a human face 211, and a target body part of the human body 210 is an elbow 212. Third correlation information between the human face 211 and the elbow 212 may be determined. Similarly, a first body part of the human body 220 is a human face 221, and a target body part of the human body 220 is an elbow 222. Thus, third correlation information between the human face 221 and the elbow 222 may be determined. A first body part of the human body 230 is a human face 231, and a target body part of the human body 230 is an elbow 232, and thus, third correlation information between the human face 231 and the elbow 232 may be determined.

It should be understood that the elbow is just an example of the target body part. In practical applications, the target body part may further be a wrist, a shoulder, a neck, a knee and any other part. In some scenarios, human face information is used to distinguish different people, which may be associated with the person's identity. In the above method, the human body bounding box is taken as an intermediary, and a human face and an elbow of a same human body are correlated by means of the human face that has been labeled in the image, thus, an identity information of a human body corresponding to the elbow may be determined, which helps to detect correlation between other body parts other than the human face and the human face, thereby determining an identity information of a person corresponding to other body parts.

In another example, a first body part is a human hand, and a target body part is an elbow, and third correlation information between the human hand and the elbow may be determined. For details, please refer to FIG. 2, which illustrates three human bodies 210, 220 and 230. A first body part of the human body 210 is a human hand 213, and a target body part of the human body 210 is an elbow 212, so that third correlation between the human hand 213 and the elbow 212 may be determined. A first body part of the human body 220 is a human hand 223, and a target body part of the human body 220 is an elbow 222. Thus, third correlation information between the human hand 223 and the elbow 222 may be determined. A first body part of the human body 230 is a human hand 233, and a target body part of the human body 230 is an elbow 232, thus, the third correlation information between the human hand 233 and the elbow 232 may be determined.

Both the target bounding box and the third correlation information may be taken as label information of the target body part involved in the image. Therefore, the target body part involved in the image is automatically labeled via the method as described above. In a case of training a neural network for recognizing action of human body or recognizing body parts based on images, a large number of images may be automatically labeled quickly, which provides sufficient training samples for the neural network, thereby reducing the difficulty to acquire training samples for the neural network.

According to the above-mentioned embodiment, it can be known that, by acquiring a human body bounding box and a target key point in an image as well as and first correlation information between the human body bounding box and the target key point, the target key point corresponds to a target body part, a target bounding box for the target body part may be generated according to the target key point and the human body bounding box; and finally, third correlation information between the target bounding box and a first bounding box for a first body part may be determined according to pre-labeled second correlation information between the human body bounding box and the first body part and the first correlation information. Thus, the target body part and the first body part may be automatically correlated, and labeling correlation between the target body part and the first body part is achieved automatically, which solves the problem of inefficient manual labeling and improves the efficiency of labeling correlation between various body parts involved in an image.

In some embodiments of the present disclosure, the human body bounding box and the target key point in the image, and the first correlation information between the human body bounding box and the target key point may be acquired as follows: first, a human body bounding box involved in the image and a human body key point in the human body bounding box are acquired; next, a target key point corresponding to the target body part is extracted from the human body key point; and finally, first correlation information between the human body bounding box and the extracted target key point.

The human body bounding box includes at least one human body key point, and the at least one human body key point may correspond to at least one body part of the human body, for example, a body part such as a wrist, a shoulder, an elbow, a human hand, a human foot, a human face, or the like. A body part of the human body corresponds to at least one human body key point. The number of human body key points corresponding to different body parts of the human body may be identical or different, which is not limited in the present disclosure.

In this step, the human body key point may be acquired as follows: the image is input into a neural network configured to detect a human body object involved in the image, and position information of the human body key point output from the neural network is acquired. Optionally, the neural network may further output position information of the human body bounding box. The neural network configured to detect the human body object involved in the image is a model trained with massive data, which can accurately extract a feature of each position of the image, and recognize content of the image based on the extracted feature. For example, the model may recognize a human body key point in the image according to the extracted feature, and determine position information of the human body key point. Optionally, the model may further determine a human body bounding box in the image according to the extracted feature, and determine the position information of the human body key point.

In this step, a margin of a corresponding human body may be determined according to the position information of the detected human body key point. And further, a bounding box surrounding the human body is constructed, thereby determining a position of the human body bounding box in the image. A belonging relationship between the human body bounding box and the human body key point may be determined according to a position inclusion relationship between the human body bounding box in the image and the human body key point.

In an example, the body part corresponding to the acquired human body key point includes at least one of followings: a human face, a human hand, an elbow, a knee, a shoulder, and a human foot. Accordingly, the human body key point include at least one of followings: a key point of the human face, a key point of the human hand, an key point of the elbow, a key point of the knee, a key point of the shoulder and a key point of the foot.

In this step, a human body key point that matches a relative position feature of the target body part is determined as a target key point by filtering position information of all the human body key points according to a relative position feature of the target body part in the human body. In an example, the human body bounding box contains a key point of a human face, a key point of a human hand, a key point of an elbow, a key point of a knee, a key point of a shoulder, and a key point of a human foot. In a case that the target body part is an elbow, a key point of the elbow may be extracted from the human body key point and taken as a target key point.

In this step, the first correlation information between the target key point and the human body bounding box may be determined according to the belonging relationship between the extracted target key point and the human body bounding box.

In some embodiments of the present disclosure, the target bounding box takes the target key point as a positioning point and meets a preset area ratio relationship with respect to at least one of the human body bounding box and a preset bounding box which is a pre-labeled bounding box for a preset body part.

The positioning point of the target bounding box may be a center of the bounding box, that is, the target key point is taken as the center of the target bounding box.

The preset area ratio relationship may be within a preset ratio range, and the ratio range may be obtained based on prior knowledge such as ergonomics, or may be determined according to statistics value of area ratio between the target body parts, the preset body part and the human body. The preset area ratio between bounding boxes for different target body parts to the human body bounding box may be different, that is, the preset area ratio between each the target bounding box to the human body bounding box may be set individually. The preset area ratios of the bounding box for the target body part and bounding boxes for different preset body parts may be different, that is, the preset area ratios of the target bounding boxes to the different preset bounding boxes may be set individually.

According to the above method, the target bounding box can be quickly constructed, and location of the target body part may be labeled.

In this step, an area of the target bounding box may be determined according to following parameters: a first weight for the human body bounding box, a preset area ratio relationship between the human body bounding box and the target bounding box, an area of the human body bounding box, a second weight for the preset bounding box, a preset area ratio relationship between the preset bounding box and the target bounding box, and an area of the preset bounding box. In other words, the target bounding box may only have a preset area ratio relationship with the human body bounding box, that is, the first weight is 1 and the second weight is 0; or the target bounding box may only have a preset area ratio relationship with the preset bounding box, that is, the first weight is 0 and the second weight is 1; or the target bounding box meets a preset area ratio relationship with the human body bounding box and the preset bounding box, respectively, that is, each of the first weight and the second weight is a ratio within a range from 0 to 1, and a summation of the first weigh and the second weight is 1.

Specifically, the area of the target bounding box may be determined according to the following equation:

S=w₁×t₁×S₁+w₂×t₂×s₂

where, S is an area of the target bounding box, w₁ is the first weight, t₁ is a preset area ratio of the human body bounding box to the target bounding box, S₁ is an area of the human bounding box, w₂ is the second weight, t₂ is a preset area ratio of the preset bounding box to the target bounding box, S₂ is an area of the preset bounding box.

The target bounding box may have a same shape as the human body bounding box. For example, the shape of the human body bounding box is rectangular, the target bounding box can also be rectangular, and the aspect ratio of the human body bounding box is the same as that of the target bounding box. For example, the preset area ratio of a target bounding box for an elbow as the target body part to the human body bounding box is 1:9. In a case that the shape of the human body bounding box is rectangular, the long and wide sides of the human body bounding box may be reduced to ⅓ in equal proportions, and thus, a long side and a wide side of the target bounding box may be acquired.

The target bounding box may have a different shape from a corresponding human body bounding box, and shapes of bounding boxes may be preset according to different body parts. For example, the human body bounding box may be a rectangle and a bounding box for the human face may be a circle. In the case that the shapes of the target bounding box and the human body bounding box are both rectangular, the aspect ratio may be different, and the aspect ratio of the rectangular bounding boxes may be preset based on different body parts.

In some scenes, a size of the human face may indicate depth information of the human body to some extent, that is, area of the bounding box for the face may indicate the depth information of the human body, so the face can be taken as a preset body part, that is, area of the target bounding box may be determined by combining the human body bounding box and the bounding box for the human face.

In some embodiment of the present disclosure, determining the target bounding box may be determining a position of the bounding box for the target body part involved in the image. For example, when the bounding box is a rectangle, coordinates of the four vertices of the bounding box may be determined. In this embodiment, the target bounding box is generated according to various constraint conditions such as the shape, the area, the preset weight and the position of the positioning point, so that the target bounding box may be determined with a high-precision, and further, label information of the target body part may be generated according to the target bounding box with a high accuracy. And moreover, the method described above solves the problem of inefficient manual labeling by automatically generating the target bounding box for the target body part, and improves the efficiency of labeling the target body part.

The human body parts include not only sole parts such as the face and the neck, but also symmetrical parts such as hands, elbows, knees, shoulders, and feet. Symmetrical parts exist in pairs and have orientation discriminating information. The orientation discriminating information is used to distinguish a position of the body part in the human body, such as left and right. Schematically, the orientation discriminating information of the left hand, the left elbow, and the left arm is “left”, and the orientation distinguishing information of the right hand, the right elbow, and the right arm is “right”. Furthermore, the first body part may be a sole part or symmetrical parts, and the target body part may be a sole part or symmetrical parts, and the types of the first body part and the target body part may determine a manner for generating the third correlation information. There are the following four situations specifically.

In the first case, that is, in a case that the first body part includes a sole part, and the target body part includes a sole part, the following manner may be employed to generate the third correlation information: generating the third correlation information by correlating a first bounding box for a first body part and a target bounding box for a target body part that are both correlated with one human body bounding box. For example, the first body part is a human face and the target body part is a neck, then the third correlation information between the human face and the neck is determined.

In the second case, that is, in a case that the first body part includes a sole part, and in a case that the target body part includes at least one of two first symmetrical parts of one human body, the third correlation information is determined as follows: first, orientation discriminating information of the target body part is acquired; next, according to the first correlation information and pre-labeled second correlation information, the first bounding box and the target bounding box that are both correlated with one human body bounding box are correlated to generate the third correlation information. The target bounding box, the third correlation information, and the orientation discriminating information of the target body part may be taken as label information of the target body part involved in the image.

For example, if the first body part is a human face, and the target body part includes the left elbow and the right elbow, third correlation information between the human face and the left elbow and third correlation information between the human face and the right elbow are determined, and then a bounding box for the left elbow, the third correlation information between the human face and the left elbow, and orientation discriminating information “left” are taken as label information for the left elbow, and a bounding box for the right elbow, the third correlation information between the human face and the right elbow and orientation discriminating information “right” is used as label information for the right elbow.

In the third case, that is, in a case that a first body part includes at least one of two second symmetrical parts of one human body, and the target body part includes a sole part, the third correlation is determined as follows: first, orientation discriminating information is acquired; and next, the first bounding box and the target bounding box that are both correlated one human body bounding box are correlated according to the first correlation information and pre-labeled second correlation information to generate third correlation information, wherein the target bounding box, the third correlation information and the orientation discriminating information of the first body part may be taken as label information for the target body part involved in the image.

For example, in a case that the target body part is a human face, and the first body part includes the left elbow, the third correlation information between the human face and the left elbow is determined, and then a bounding box for the human face, the third correlation information between the human face and the left elbow, and the orientation discriminating information “left” may be taken as label information for the human face.

In the fourth case, that is, in a case that the target body part includes at least one of two first symmetrical parts of one human body and the first body part includes at least one of two second symmetrical parts of one human body, the third correlation information may be determined as follows: first, orientation discriminating information of the target body part is acquired and orientation discriminating information of the first body part is acquired; next, the first bounding box and the target bounding box that are both correlated to one human body bounding box and have same orientation discriminating information are correlated according to the first correlation information and pre-labeled second correlation information; and finally, third correlation information may be generated according to a result of correlating the first bounding box and the target bounding box; wherein the target bounding box, the third correlation information and the orientation discriminating information for the target body part may be taken as label information of the target body part involved in the image.

For example, in a case that the first body part includes the left hand and the right hand, and the target body part includes the left elbow and the right elbow, third correlation information between the left hand and the left elbow and third correlation information between the right hand and the right elbow may be determined according to the detected left and right hands and position relationships of the left hand and the right hand with respect to the two elbows respectively, and further, a bounding box for the left elbow, the third correlation information between the left hand and the left elbow and orientation discriminating information “left” may be taken as label information for the left elbow, and the a box for the right elbow, the third correlation information between the right hand and the right elbow and orientation discriminating information “right” are taken as label information for the right elbow.

The second correlation information may be acquired based on label information of the first body part, that is, the label information of the first body part may include a correspondence between the first body part, the human body, and the human body bounding box. The second correlation information may further be acquired from a correspondence between the human body bounding box and the human body key point in the human body bounding box, specifically, a correspondence between the first body part, the human body, and the human body bounding box may be acquired via the correspondence between the first body part and the human body key point in the first body part and the correspondence between the human key point and the human bounding box.

The label information for the first body part may further include orientation discriminating information corresponding to at least one second symmetrical part, that is, to label left or right for at least one symmetrical part correspondingly, such that the orientation discriminating information may be acquired from the label information for the first body part. The orientation discriminating information of the first body part can further be determined based on both the human body bounding box and the human body key points corresponding to the first body part, that is, the two second symmetrical parts have different human body key points, so that orientation discriminating information of the second symmetrical parts may be determined according to position information of the key points included in the second symmetrical parts, that is, in a case that a direction of the human body key point is left, orientation discriminating information for the corresponding second symmetrical part is left, and in a case that a direction of the human body key point is right, orientation discriminating information of the corresponding second symmetrical part is right. The orientation discriminating information of the target body part can also be determined based on both the human body bounding box and the target key point corresponding to the target body part. The specific acquiring manner is the same as the manner in which the orientation discriminating information of the first body part is acquired, and will not be elaborated here.

A target bounding box for the target body part and a first bounding box for the first body part that are both correlated with one human body bounding box may be determined according to the position belonging relationship, that is, the target bounding box and the first bounding box that are both contained in one human body bounding box are taken as the target bounding box and the first bounding box that are both correlated with one human body bounding box.

In the embodiments of the present disclosure, the third correlation information may be determined through different manners according to different types of the first body part and the target body part, thereby improving the accuracy of the correlation between the first body part and the target body part.

In the embodiment of the present disclosure, a correlation tag may be generated for the target body part according to both the third correlation information and the orientation discriminating information of the target body part after determining the third correlation information.

In a case of training a neural network for recognizing human actions or recognizing body parts with the image, the correlation tag may be taken as a tag of the target body part involved in the image. Further, the correlation tag may contain orientation discriminating information, thus the positions of symmetrical body parts are discriminated, which further improves the accuracy of labeling the target body part, thereby improving efficiency and quality of training the neural network.

In some embodiments of the present disclosure, the method of processing image further includes: generating fifth correlation information according to the second correlation information and pre-labeled fourth correlation information, wherein the fourth correlation information indicates a correlation between a second body part and the human body bounding box, and the fifth correlation information indicates a correlation between the target bounding box and a second bounding box for the second body part.

The second body part is a labeled body part, and its label information may include a position of the bounding box for the second body part, a part name, orientation discriminating information, a correspondence relationship with the human body, and so on. Therefore, the fourth correlation information may be acquired based on the label information for the second body part, that is, the correlation between the second body part and the human body bounding box may be determined by the correlation between the second body part and a human body involved in the human body bounding box.

The fourth correlation information can further be acquired from a correspondence between the human body bounding box and the human body key points in the human body bounding box. The specific acquiring manner is the same as the manner in which the first body part is acquired, and will not be elaborated here.

There are four cases according to the types of the first body part and the second body part, namely, a first case that both the first body part and the second body part are sole parts, a second case that the first body part is a symmetrical part and the second body part is a sole part, a third case that the first body part is a sole part, and the second body part is a symmetrical part, and a fourth case that both the first body part and the second body part are symmetrical parts. It should be understood by one of ordinary skill in the art that the manner of determining the fifth correlation information in the above four cases may refer to the manner of determining the third correlation information, which will not be elaborated here.

In an embodiment of the present disclosure, the first body part is different from the second body part, and the second body part is one of following parts: a human face, a human hand, an elbow, a knee, a shoulder, and a human foot.

For example, in a case that the first body part is a human face and the second body part is a human hand, the fifth correlation information between the human face and the human hand may be determined; please refer to FIG. 2 for details, which illustrates three human bodies 210, 220 and 230, a first body part of the human body 210 is a human face 211, and a second body part of the human body 210 is a human hand 213, and fifth correlation information between the human face 211 and the human hand 213 may be determined; a first body part of the human body 220 is a human face 221, a second body part of the human body 220 is a human hand 223, and fifth correlation information between the human face 221 and the human hand 223 may be determined; a first body part of the human body 230 is a human face 231, and a second body part of a human body 230 is a human hand 233, and fifth correlation information between the human face 231 and the human hand 233 may be determined.

In the embodiments of the present disclosure, by determining the fifth correlation information, label information for the image may be further enriched. Therefore, the image can be applied to train a multi-task neural network, such as a neural network configured to detect correlation between an elbow, a human face and a human hand, thus reducing the difficulty of collecting samples for training a multi-task neural network, which helps to improve quality of training multi-task neural network.

In some embodiments of the present disclosure, the method of processing image further includes: displaying a respective correlation indicating information in the image according to the third correlation information, or displaying a respective correlation indicating information in the image according to both the second correlation information and the third correlation information.

The correlation indicating information may be displayed in the form of connecting line, that is, the third correlation information may be displayed as a connecting line connecting the target bounding box for the target body part and the first bounding box for the first body part.

In an embodiment of the present disclosure, the target body part is the left hand, and the first body part is the left elbow. After determining the third correlation information between the left hand and the left elbow, the bounding box for the left hand and the bounding box for the left elbow may be connected by a connecting line which is taken as corresponding correlation indicating information. For details, please refer to FIG. 2, which illustrates three human bodies 210, 220 and 230. A target body part of the human body 210 is the left hand 213, and a first body part of the human body 210 is the left elbow 212, a connecting line connecting a bounding box for the left hand 213 and a bounding box for the left elbow 212 may be taken as a correlation indicating information for the third correlation information between the bounding box for the left hand 213 and the bounding box for the left elbow 212; a target body part of the human body 220 is the left hand 223, a first body part of the human body 220 is the left elbow 222, and a connecting line connecting the bounding box for the left hand 223 and the bounding box for the left elbow 222 may be taken as third correlation indicating information for the third correlation information between the bounding box for the left hand 223 and the left elbow 222. A target body part of the human body 230 is the left hand 233, and the first body part of the human body 230 is the left elbow 232. A connecting line connecting the bounding box for the left hand 233 and the bounding box for the left elbow 232 may be taken as third correlation indicating information for the third correlation between the left hand 233 and the left elbow 232.

Correspondingly, a respective correlation indicating information may be displayed in the image according to the fifth correlation information, or a respective correlation indicating information may be displayed in the image according to both the fourth correlation information and the fifth correlation information. The correlation information may be indicated by a connecting line connecting the first bounding box for the first body part and the second bounding box for the second body part.

In a case that the third correlation information and the fifth correlation information are displayed on the image, a correlation indicating information of the first body part, the target body part, and the second body part is generated. For example, the first body part is a human face, the target body part is the left elbow, and the second body part is the left hand, correlation indicating information of the human face, the left elbow and the left hand is generated. For details, please refer to FIG. 2, which illustrates three human bodies 210, 220 and 230. A first body part of the human body 210 is a human face 211, a target body part of the human body 210 is the left elbow 212, and a second body part of the human body 210 is the left hand 213. A bounding box for the human face 211, and a bounding box for the left elbow 212, and a bounding box for the left hand 213 are connected in sequence to generate correlation indicating information of the human face 211, the left elbow 212, and the left hand 213. A first body part of the human body 220 is the human face 221, and a target body part of the human body 220 is the left elbow 222, a second body part of the human body 220 is the left hand 223, and a bounding box for the human face 221, a bounding box for the left elbow 222, and a bounding box for the left hand 223 may be connected in sequence to generate correlation indicating information of the human face 221, the left elbow 222 and the left hand 223. A first body part of the human body 230 is a human face 231, a target body part of the human body 230 is the left elbow 232, and a second body part of the human body 230 is the left hand 233, a bounding box for the human face 231, a bounding box for the left elbow 232, and a bounding box for the left hand 233 may be connected in sequence to generate correlation indicating information of the human face 231, the left elbow 232, and the left hand 233.

The correlation indicating information is not limited to be displayed in the form of the connecting line. The correlation indicating information may further be displayed in other manners, such as indicating various body parts correlated to a same human body with bounding boxes of a same color, indicating personal identity indicator at various part of a same human body, and etc.

In the embodiments of the present disclosure, by displaying at least one of the third correlation information and the fifth correlation information, the label result can be displayed intuitively, which facilitates a labeling operator to check the label result of correlation. In a case of being applied to human action detection and tracking, human action and tracking result may be displayed by the correlation indicating information, so as to evaluate a result of detecting the correlation.

According to a second aspect of the present disclosure, there is provided a method of training a neural network, the neural network is configured to detect a correlation between body parts involved in an image, the method includes: training the neural network with an image training set; wherein an image in the image training set is labeled with label information, the label information includes correlation information between a first body part and a target body part involved in the image, and the correlation information is determined according to the method of the first aspect.

The third correlation information acquired by the image processing method mentioned above is used to label an image in the image training set, such that label information which is more accurate and reliable may be acquired, thus the neural network which is trained and which is configured to detect the correlation between the body parts involved in the image has a relatively high accuracy.

According to a third aspect of the present disclosure, there is provided a method of recognizing an action, which includes: recognizing an action of a human body involved in an image based on correlation information between a first body part and a target body part involved in the image, wherein the correlation information is acquired with a neural network trained by the method described in the second aspect.

According to correlation information between human body parts predicted by the neural network configured to detect a correlation between body parts involved in an image, different body parts of a same human body may be accurately correlated in human action detection, thereby helping to analyze relative positions and angular relationship between various body parts of a same human body, and further to determine a human body action, thereby acquiring relatively accurate result of recognizing a human body action.

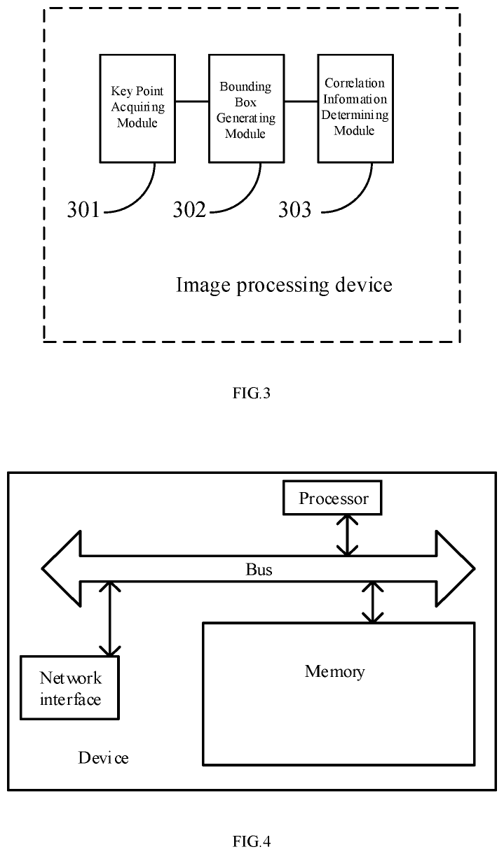

Referring to FIG. 3, according to a fourth aspect of the present disclosure, a device of processing image is provided, including:

a key point acquiring module 301, configured to acquire a human body bounding box and a target key point corresponding to a target body part in an image, and first correlation information between the human body bounding box and the target key point;

a bounding box generating module 302, configured to generate a target bounding box for the target body part according to the target key point and the human body bounding box; and

a correlation information determining module 303, configured to determine third correlation information according to the first correlation information and pre-labeled second correlation information, where the second correlation information indicates a correlation between a first body part and the human body bounding box, and the third correlation information indicates a correlation between the target bounding box and a first bounding box for the first body part.

According to a fifth aspect of the present disclosure, there is provided a device of training a neural network, the neural network is configured to detect a correlation between body parts involved in an image, and the device includes:

a training module, configured to train the neural network with an image training set;

wherein an image in the image training set is labeled with label information, and the label information includes correlation information between a first body part and a target body part involved in the image, and the correlation information is determined via the method described in the first aspect.

According to a sixth aspect of the present disclosure, there is provided a device, the device of recognizing an action, including:

a recognizing module, configured to recognize an action of a human body involved in an image based on correlation information between a first body part and a target body part involved in the image, wherein the correlation information is acquired with a neural network trained by the method according to the second aspect.

Regarding the device in the foregoing embodiment, specific manners in which each module operates has been described in detail in the embodiments of the methods according to third aspect of the present disclosure, which will not be elaborated here.

Referring to FIG. 4, according to a seventh aspect of the present disclosure, an electronic apparatus is provided. The apparatus includes memory and a processor. The memory is configured to store computer instructions executable by the processor. The processor is configured to implement operations of any one of the methods described in the first aspect, the second aspect or the third aspect in a case of executing the computer instructions.

According to an eighth aspect of the present disclosure, there is provided a computer-readable storage medium having a computer program stored thereon, in a case that the program is executed by a processor, operations of the method described in the first, second, or third aspect are implemented.

In the present disclosure, the terms “first” and “second” are only used for descriptive purposes, and cannot be understood as indicating or implying relative importance. The term “plurality” refers to two or more, unless specifically defined otherwise.

Those skilled in the art will easily think of other embodiments of the present disclosure after considering the description and practicing the disclosure disclosed herein. The present disclosure is intended to cover any variations, applications or adaptive changes of the present disclosure. These variations, applications or adaptive changes follow the general principles of the present disclosure and include common knowledge or conventional technical means in the technical field not disclosed by the present disclosure. The description and the embodiments are to be regarded as exemplary only, and the true scope and spirit of the present disclosure are defined by the appended claims.

It should be understood that the present disclosure is not limited to the exact structure described above and illustrated in the drawings, and various modifications and changes can be made without departing from its scope. The scope of the present disclosure is only defined by the appended claims.

What is claimed is:

1. A method of processing image, comprising:
acquiring a human body bounding box and a target key point corresponding to a target body part in an image, and acquiring first correlation information between the human body bounding box and the target key point;
generating a target bounding box for the target body part according to the target key point and the human body bounding box; and
determining third correlation information according to the first correlation information and pre-labeled second correlation information,
wherein the second correlation information indicates a correlation between a first body part and the human body bounding box, and the third correlation information indicates a correlation between the target bounding box and a first bounding box for the first body part.

2. The method according to claim 1, wherein acquiring the human body bounding box and the target key point corresponding to the target body part in the image, and acquiring the first correlation information between the human body bounding box and the target key point comprises:
acquiring the human body bounding box in the image and human body key points in the human body bounding box;
extracting the target key point corresponding to the target body part from the human body key points; and
generating the first correlation information between the human body bounding box and the target key point.

3. The method according to claim 1, wherein generating the target bounding box for the target body part according to the target key point and the human body bounding box comprises:
generating the target bounding box that is with the target key point as a positioning point and meets a preset area ratio relationship with respect to at least one of the human body bounding box or a preset bounding box that is a pre-labeled bounding box for a preset body part.

4. The method according to claim 3, further comprising determining an area of the target bounding box according to at least one of:
a first weight for the human body bounding box,
a preset area ratio relationship between the human body bounding box and the target bounding box,
an area of the human body bounding box,
a second weight for the preset bounding box,
a preset area ratio relationship between the preset bounding box and the target bounding box, or
an area of the preset bounding box.

5. The method according to claim 1, wherein determining the third correlation information according to the first correlation information and the pre-labeled second correlation information comprises:
generating the third correlation information by correlating the first bounding box and the target bounding box that are both correlated with the human body bounding box.

6. The method according to claims 1, further comprising:
acquiring orientation discriminating information of the target body part,
wherein the target body part comprises at least one of two first symmetrical parts of a human body.

7. The method according to claim 6, wherein determining the third correlation information according to the first correlation information and the pre-labeled second correlation information comprises:
acquiring orientation discriminating information of the first body part that comprises at least one of two second symmetrical parts of the human body;
in response to determining that the first bounding box and the target bounding box are both correlated with the human body bounding box and that orientation discrimination information of the first bounding box is same as orientation discrimination information of the target bounding box, correlating the first bounding box and the target bounding box according to the first correlation information and the pre-labeled second correlation information, wherein the orientation discrimination information of the first bounding box corresponds to the orientation discriminating information of the first body part, and the orientation discrimination information of the target bounding box corresponds to the orientation discriminating information of the target body part; and
generating the third correlation information according to a result of correlating the first bounding box and the target bounding box.

8. The method according to claim 6, wherein acquiring orientation discriminating information of the target body part comprises:
determining orientation discriminating information of the target body part according to the human body bounding box and the target key point corresponding to the target body part.

9. The method according to claim 6, further comprising:
generating a correlation tag for the target body part according to the third correlation information and the orientation discriminating information of the target body part.

10. The method according to claim 1, wherein each of the first body part and the target body part comprises one of: a human face, a human hand, an elbow, a knee, a shoulder, or a human foot.

11. The method according to claim 1, further comprising:
generating fifth correlation information according to the second correlation information and pre-labeled fourth correlation information,
wherein the fourth correlation information indicates a correlation between a second body part and the human body bounding box, and the fifth correlation information indicates a correlation between the target bounding box and a second bounding box for the second body part.

12. The method according to claim 11, wherein the first body part is different from the second body part, and
wherein the second body part comprises one of a human face, a human hand, an elbow, a knee, a shoulder, or a human foot.

13. The method according to claim 1, further comprising:
displaying corresponding correlation indicating information in the image according to the third correlation information, or
displaying corresponding correlation indicating information in the image according to both the second correlation information and the third correlation information.

14. An electronic apparatus, comprising:
at least one processor; and
one or more memories coupled to the at least one processor and storing programming instructions for execution by the at least one processor to perform operations comprising:
acquiring a human body bounding box and a target key point corresponding to a target body part in an image, and acquiring first correlation information between the human body bounding box and the target key point;
generating a target bounding box for the target body part according to the target key point and the human body bounding box; and
determining third correlation information according to the first correlation information and pre-labeled second correlation information,
wherein the second correlation information indicates a correlation between a first body part and the human body bounding box, and the third correlation information indicates a correlation between the target bounding box and a first bounding box for the first body part.

15. The electronic apparatus according to claim 14, wherein the operations further comprise:
training a neural network with an image training set, the neural network being configured to detect a correlation between body parts involved in a training image in the image training set;
wherein the training image in the image training set is labeled with label information,
wherein the label information comprises correlation information between a first body part and a target body part involved in the training image in the image training set.

16. The electronic apparatus according to claim 15, wherein the operations further comprise:
acquiring correlation information between the first body part and the target body part involved in the image by using the neural network; and
recognizing an action of a human body involved in the image based on the correlation information between the first body part and the target body part involved in the image.

17. The electronic apparatus according to claim 14, wherein the operations comprise:
acquiring the human body bounding box in the image and human body key points in the human body bounding box;
extracting the target key point corresponding to the target body part from the human body key points; and
generating the first correlation information between the human body bounding box and the target key point.

18. The electronic apparatus according to claim 14, wherein generating the target bounding box for the target body part according to the target key point and the human body bounding box comprises:
generating the target bounding box that is with the target key point as a positioning point and meets a preset area ratio relationship with respect to at least one of the human body bounding box and a preset bounding box that is a pre-labeled bounding box for a preset body part.

19. The electronic apparatus according to claim 18, wherein the operations further comprise determining an area of the target bounding box according to at least one of:
a first weight for the human body bounding box,
a preset area ratio relationship between the human body bounding box and the target bounding box,
an area of the human body bounding box,
a second weight for the preset bounding box,
a preset area ratio relationship between the preset bounding box and the target bounding box, or
an area of the preset bounding box.

20. A non-transitory computer-readable storage medium coupled to at least one processor and storing programming instructions for execution by the at least one processor to perform operations comprising:
acquiring a human body bounding box and a target key point corresponding to a target body part in an image, and acquiring first correlation information between the human body bounding box and the target key point;
generating a target bounding box for the target body part according to the target key point and the human body bounding box; and
determining third correlation information according to the first correlation information and pre-labeled second correlation information,
wherein the second correlation information indicates a correlation between a first body part and the human body bounding box, and the third correlation information indicates a correlation between the target bounding box and a first bounding box for the first body part.
